(19) United States
(12) Patent Application Publication
(10) Pub. No.: US 2025/0003270 A1
(43) Pub. Date: Jan. 2, 2025

(54) Door Wedge Tool

(71) Applicant: Mainstay Safety LLC, Freeville, NY (US)

(72) Inventor: Landon Fletcher, Freeville, NY (US)

(21) Appl. No.: 18/760,714

(22) Filed: Jul. 1, 2024

Related U.S. Application Data
(60) Provisional application No. 63/511,447, filed on Jun. 30, 2023.

(51) Int. Cl. E05C 17/54

(52) U.S. Cl. CPC E05C 17/54

(57) ABSTRACT

A door wedge tool includes a base surface, an end surface defining a first angle with the base surface and extending from a first end of the base surface, a primary wedging surface defining a second angle with the base surface and extending from a second end of the base surface. A magnet can be recessed through the base surface, and/or a secondary wedging surface non-parallel with the primary wedging surface and the end surface can connect the end surface and the primary wedging surface.

### REFERENCE TO RELATED APPLICATIONS

This application claims one or more inventions disclosed in Provisional Application No. 63/511,447, filed Jun. 30, 2023, entitled “Door Wedge Device”. The benefit under 35 USC § 119(e) of the United States provisional application is hereby claimed, and the aforementioned application is hereby incorporated herein by reference.

### BACKGROUND

The present invention relates to tools, and more specifically to door wedge tools.

Door stoppers or wedges have the shape of triangular prims or wedges and are used to obstruct doors from closing, or prop the doors open. Door wedges, which are typically made of rubber, plastic, wood, or metal, can be wedged under the bottom of a door, squeezed in the space between the floor and the door. FIG. 1 shows a side view of a conventional door wedge 1. The door wedge 1 has a base surface 11 that is intended to be placed against the floor, a wedging surface 12 that is intended to be pressed or wedged into contact with the bottom of the door, and an end surface 13 that connects the base surface 11 to the wedging surface 12. An angle A between the base surface 11 and the wedging surface 12 is strictly less than 45 degrees, but usually between 15 and 30 degrees, such that the door may slide some distance along and against the wedging surface 12 until force from the door through the door wedge 1 against the floor creates sufficient sliding friction to prevent the door wedge 1 from sliding against the floor. The door in this circumstance is obstructed from closing further by the portion of the wedging surface 12 that is in the door's closing path.

Generally, to reduce complexity and simplify manufacturing of the wedge 1, an angle C between the base surface 11 and the end surface 13 is a right angle, and accordingly an angle B between the wedging surface 13 and the end surface 12 is complementary to the angle A. In some instances, as compared to the embodiment in FIG. 1, the angle C is reduced from 90 degrees, the angle B is increased by an identical amount, and the wedging surface 12 is shortened.

An open door that swings to close in a certain closing direction can be prevented from being closed by placing the wedge 1 under the door with the base surface 11 on the floor, the wedging surface 12 facing the door, and the end surface 13 facing away from the door toward the closing direction and the frame of the door.

Door wedges are commonly used by first responders in a variety of emergency situations. Firefighters use door wedges to keep doors open, for example, to ensure mobility of personnel in a hazardous firefighting environment, to prevent doors from closing on a fire hose being dragged through the doorway, or to maintain a path of ventilation through a doorway. Similarly, EMTs may use door wedges to keep doors open to facilitate transport of patients through doorways to prevent delays to the time-critical emergency medical response.

Conventional door wedges suffer from various limitations that can make them ineffective in common scenarios. For example, when speed is a concern, such as in an emergency responder situation, finagling a door wedge tightly in position under a door sufficiently to keep the door open can be relatively time consuming. Further, door wedges propping open a door are often directly kicked by passersby, thereby loosening the tight fit of the wedge under the door and allowing the bias of the door toward the closed position to overpower the weakened sliding friction of the base surface 11 against the floor. Passersby bumping the door can have the same effect.

In some cases, door frames are located at the top end of a stairway and accordingly there may be a considerable distance between the floor and the bottom of the door if the door is hinged such that it swings open above the stairway, therefore making it impossible to wedge the door open by placing a wedge 1 under the door. Similarly, in some cases outdoor facing doorways are raised relative to the ground to prevent entry of rainwater into the building. In other cases, the door is constructed such that there is very little room between the door and the floor, or the door has a rubber draft stopper seal installed to prevent airflow through the space between the door and the floor, therefore making it impossible to place a wedge 1 under the door due to a lack of space. In these situations, a conventional door wedge is not functional, and first responders may have to accept the risk of not being able to wedge some doors or carry a different and additional wedging tool that is specialized for wedging a door open when placed over its opened hinge between the door and the door frame or at the top of the door against the upper door jamb, thus increasing total equipment weight and cost, as well as requiring more rigorous training for the more complex concurrent use of multiple wedging devices to avoid time-wasting user errors that may occur during emergencies.

Further, because door wedges are used in emergency situations where visibility may be decreased, such as a lack of lighting due to night conditions and/or lack of power to electric lighting devices or the presence of thick smoke, first responders are frequently unable to quickly locate the door wedge after having placed it under a doorway and left the area to accomplish other tasks. It is important for a first responder to be able to quickly locate and remove the door wedge if the emergency situation has dynamically changed such that operating the door normally is critical to security and/or safety.

Accordingly, there is a need in the art for a door wedging device that can be used in a versatile manner in situations where a conventional door wedge may not function effectively, as well as a need for a door wedging device with improved visibility in low-visibility conditions.

### SUMMARY

A door wedge tool is disclosed that can be used with more versatility and functionality than a conventional door wedge, that facilitates expedient and convenient installation in a doorway, that can be used with otherwise problematic doors, that reduces the chance of being rendered nonfunctional by passersby kicking the door wedge tool or bumping the door, and that facilitates visibility of the door wedge tool and a corresponding doorway.

According to an embodiment, a door wedge tool includes: a base surface; an end surface defining a first angle with the base surface and extending from a first end of the base surface; a primary wedging surface defining a second angle with the base surface and extending from a second end of the base surface; and a magnet recessed through the base surface.

In another embodiment, a door wedge tool includes a base surface; an end surface defining a first angle with the base surface and extending from a first end of the base surface; a primary wedging surface defining a second angle with the base surface and extending from a second end of the base surface, the second angle being less than 45 degrees; and a secondary wedging surface connecting the end surface and the primary wedging surface, the secondary wedging surface being non-parallel with the primary wedging surface and the end surface.

### BRIEF DESCRIPTION OF THE DRAWINGS

FIG. 1 shows a side view of a conventional door wedge.

FIG. 2 shows a perspective view of a door wedge tool, according to an embodiment.

FIG. 3 shows another perspective view of the door wedge tool of FIG. 2.

FIG. 4 shows a cross-sectional view of the door wedge tool of FIG. 2.

FIG. 5 shows a view of a base surface of the door wedge tool of FIG. 2.

FIG. 6 shows a perspective view of the door wedge tool of FIG. 2 installed in a first orientation between a door and a door frame.

FIG. 7 shows a perspective view of the door wedge tool of FIG. 2 installed on a hinge in a second orientation.

FIG. 8 shows a perspective view of the door wedge tool of FIG. 2 installed adjacent a strike plate.

FIG. 9 shows a partial cross-sectional view of the door wedge tool of FIG. 2.

FIG. 10 shows a side view of the door wedge tool of FIG. 2.

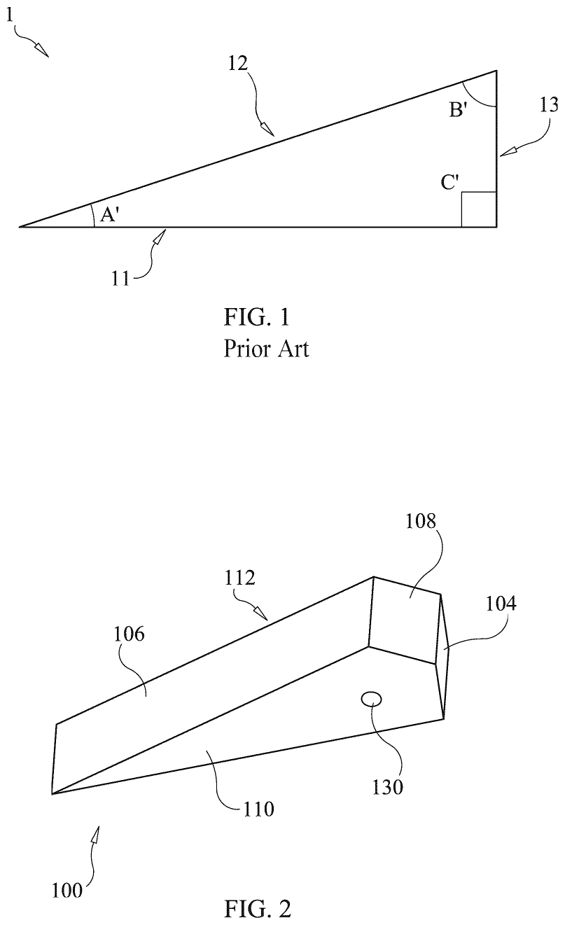

### DETAILED DESCRIPTION

In the following description, reference is made to the accompanying drawings that form a part thereof, and in which is shown by way of illustration specific example embodiments in which the present teachings may be practiced. These embodiments are described in sufficient detail to enable those skilled in the art to practice the present teachings and it is to be understood that other embodiments may be utilized and that changes may be made without departing from the scope of the present teachings.

The terminology used herein is for the purpose of describing particular example embodiments only and is not intended to be limiting. As used herein, the singular forms “a”, “an”, and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the Figures. Spatially relative terms may be intended to encompass different orientations of the device in use or operation in addition to the orientation depicted in the Figures. For example, if the device in the Figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terms “approximately” and “about”, when qualifying a quantity, shall mean the quantity with a tolerance plus or minus 10 percent of the quantity, unless otherwise specified.

FIGS. 2 and 3 each show a perspective view of a door wedge tool 100. The door wedge tool 100 is intended to be able to be used conventionally between the bottom of a door and a floor, or additionally in the hinge jamb, against a hinge, or against a strike plate. Facilitating the door wedge tool 100 to be able to be used in each of these manners, the door wedge tool 100 has a base surface 102, an end surface 104, a primary wedging surface 106, and a secondary wedging surface 108. The base surface 102 connects the end surface 104 with the primary wedging surface 106. The secondary wedging surface 108 connects the end surface 104 and the primary wedging surface 106. Each surface 102, 104, 106, 108 is angled differently and together, these surfaces 102, 104, 106, 108 complete a fully annular path. Each of these surfaces 102, 104, 106, 108 can be connected by a first lateral surface 110 and a second lateral surface 112.

The surfaces 102, 104, 106, 108 can have a width, for example, of approximately 1.5-2.5 inches (approximately 3.81-6.35 cm). An angle A between the base surface 102 and the primary wedging surface 106 is less than 45 degrees, preferably in the range of 15-30 degrees. An angle C between the base surface 102 and the end surface 104 can be a right angle. An angle D between the end surface 104 and the secondary wedging surface 108 can be approximately 135 degrees. An angle B between the primary wedging surface 106 and the secondary wedging surface 108 can be more than 90 degrees, preferably in the range of 105-120 degrees.

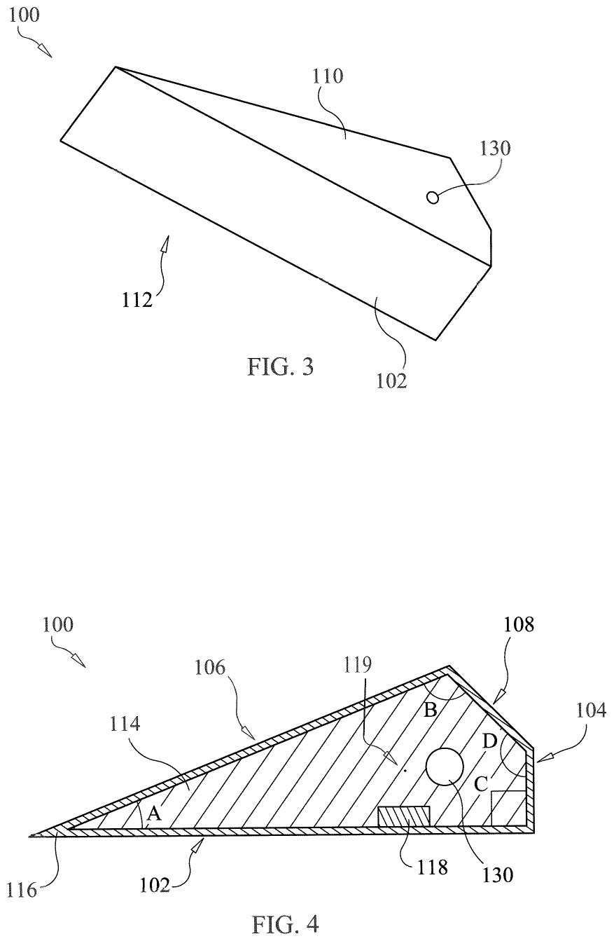

When used in a conventional manner, the base surface 102 is intended to be placed in contact with a floor such that the primary wedging surface 106 engages the bottom of a door. Referring additionally to FIG. 4, which shows a cross-sectional view of the door wedge tool 100, one or more of the surfaces 102, 104, 106, 108 can be formed with a material having a relatively high coefficient of friction, such as rubber or a soft or textured plastic. In some instances, such as is shown in FIG. 4, appropriate portions of a wedge body 114 can be coated with an anti-slip element 116 having a higher coefficient of friction than the material of the wedge body 114. For example, the wedge body 114 can be made of wood or hard plastic, and the anti-slip element 114 can be grip tape, cloth, rubber, leather, glue, or plastic. The anti-slip element 116 can be textured. Within this disclosure, when used in relation to coatings and layers, the terms “coated” and “adhered” should be interpreted to mean that the coating or layer is affixed to the specified feature, with or without intervening elements or layers, by any means including but not limited to adhesives.

The anti-slip element 116 improves the performance of the wedge 100 as compared to conventional door wedges, by increasing the frictional force that can be generated by the wedge 100 to keep doors open. The wedge 100 as described above can be used in all situations where a conventional wedge would be used, with improved performance due to the addition of the anti-slip element 116 which increases friction relative to conventional designs.

In some embodiments, the anti-slip element 116 additionally extends to the edges of the lateral surfaces 110, 112, or covers them in their entirety, such that a high-friction anti-slip surface is additionally provided on the lateral surfaces 110, 112.

A hole 130 can extend between and through the first lateral surface 110 and the second lateral side 112. A retention aid such as a lanyard can be passed through the hole 130 to provide an attachment for the door wedge tool 100 to be carried or attached to another device.

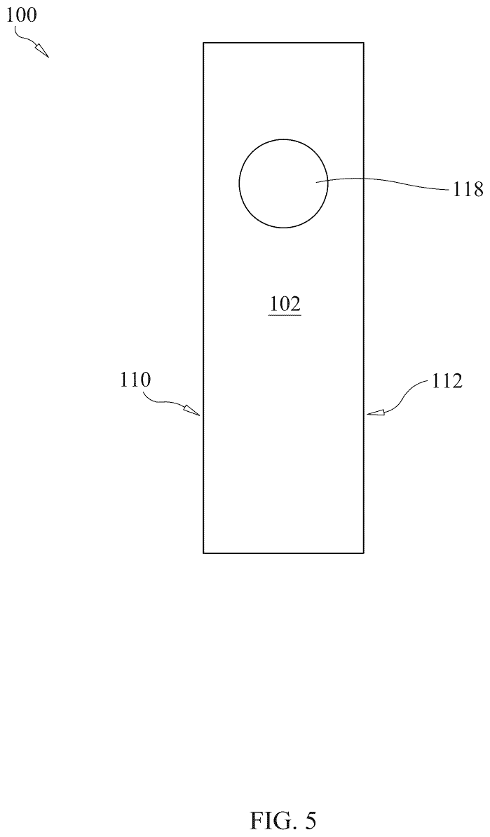

To facilitate use of the door wedge in a hinge jamb or door jamb, a magnet 118 is embedded under or flush with the base surface 102. FIG. 4 and FIG. 5 show an exemplary embodiment of the magnet 118. Positioning of the magnet 118 along the base surface 104 toward the end surface 104 or toward a center of gravity 119 of the door wedge tool 100 facilitates good horizontal (with respect to the Earth's surface) use/placement of the door wedge tool 100. The magnet can be located along the base surface 104 offset from the center of gravity 119 approximately perpendicular with respect to the base surface 104. This position of the magnet 118 is closer to the end surface 104 than the primary wedging surface 106. A recess or hole through the base surface 102 into the wedge body 114 is shaped and sized to receive the magnet 118. The magnet 118 can be secured in the recess by, for example, adhesive or an interference fit. The anti-slip element 116, when used, can also cover the magnet 118 and thereby assist retention of the magnet 118 in the recess.

The magnet 118 can be composed of ceramic or rare-earth. When the base surface 102 of the wedge 100 is placed on a magnetic surface, the magnet 118 is strongly attracted to the surface, thereby pulling the wedge body 114 and the base surface 102 toward/against the magnetic surface. Friction generated between the base surface 100 and the magnetic surface is strong enough to hold the door wedge tool against a vertical magnetic surface without succumbing to gravity, despite impacts and vibrations through the door wedge tool 100 and the magnetic surface.

The magnet 118 can be placed anywhere along the base 101. Positioning the magnet at or offset from the center of gravity 119 approximately perpendicularly with respect to the base surface 102 along the base surface 102 facilitates stability during use. In the illustrated embodiment, the magnet 118 is positioned along a central axis of the base surface 102 closer to an intersection of the base surface 102 with the end surface 104 than an intersection of the base surface 102 with the primary wedging surface 106.

The magnet 118 allows for the door wedge tool 100 to be used in multiple situations where conventional door wedges would be ineffective, such as those situations mentioned in the background section above.

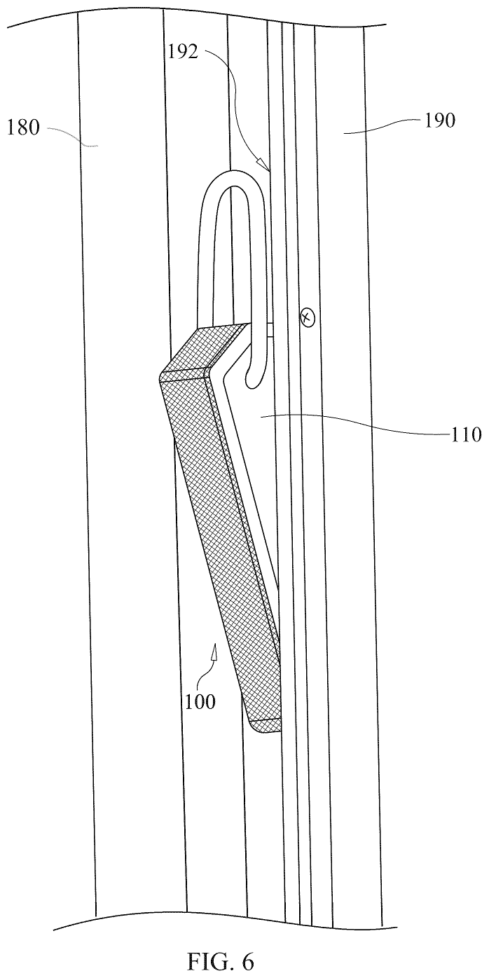

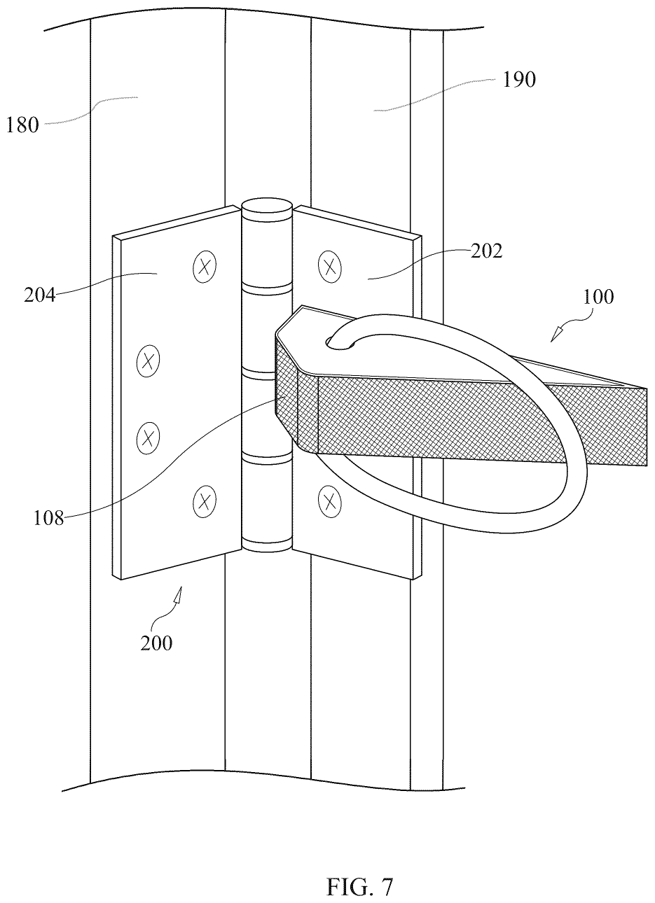

As shown in FIGS. 6-7, the door wedge tool 100 can be used to keep a door 180 open by magnetically adhering the door wedge tool 100 to a metallic or magnetic portion or component of the door frame 190 or door jamb 192, such as one of the metal hinges 200, a strike plate (not shown), or a latch receiver assembly 220.

Referring to FIG. 7, door hinges 200 can have a frame leaf 202 affixed to the door frame 190 and a door leaf 204 affixed to the door 180, with the leaves 202, 204 rotating about a hinge 206 to become adjacent to each other or approximately mate when the door is closed. The wedge 100 can be placed in a first orientation (vertical with respect to the Earth surface) as shown in FIG. 6, or in a second orientation (horizontal with respect to the Earth surface) as shown in FIG. 7.

In the first orientation, as shown in FIG. 6, the door wedge tool 100 is placed such that the magnet 118 is attracted to either the door 180 (or door leaf 204, shown in FIG. 7) or the frame 190 (or frame leaf 202 shown in FIG. 7), and the base surface 102 of the wedge 100 is aligned lengthwise with the door 180 or the frame 190. With the door wedge tool 100 installed as such, the door 180 is unable to close due to the presence of the door wedge tool 100 in the doorjamb (or hinge 200 shown in FIG. 7) within the space between the door 180 (or door leaf 204 shown in FIG. 7) and the frame 190 (or frame leaf 202 shown in FIG. 7), such that the door 180 cannot close. The magnetic force pulls the magnet 118 and the base surface 102 toward the metallic or magnetic surface upon which the base surface 102 is positioned. The static frictional force further facilitates retention of the door wedge tool 100 in place to obstruct the door 180 from closing. As the door swings to close, the door wedge tool 100 may become jammed between the edges of the door 180 and the door frame 190, and thus be further held in place by the force exerted on the door wedge tool 100 by the door 180.

Additional anti-slip element 116 on the lateral surfaces 110, 112 may further increase the frictional force between the door, the door frame, and the door wedge tool 100, which reduces the chance that the door wedge tool 100 will be dislodged. Placing the wedge 100 in this position to keep a door open is an action that can be performed quickly without requiring the user to reach downwards to place the door wedge tool 100 under the door, thus preventing unnecessary strain to the user due to back bending under heavy equipment loads and allowing the user to maintain mobility and focus in order to better react to dangers and/or threats. The secondary wedging surface 108, which can be created by eliminating one of the otherwise three points of a triangular wedge, facilitates seating of the door wedge tool 100 inside the door hinge area. This secondary wedging surface 108 can abut a door, frame, jamb, or the like to facilitate forcing the door to open or remain open.

In the second orientation, as shown in FIG. 7, the door wedge tool 100 is placed such that the magnet 118 is attracted to either the frame leaf 202 or the door leaf 204 of the hinge 200, and the base surface 102 of the door wedge tool 100 is perpendicular to the frame or the door. The lateral surfaces 110, 112 of the door wedge tool 100 face upwards and downwards, and the end surface 104 faces either the frame leaf 202 or the door leaf 204 depending on which of the two is being attracted by the magnet. With the door wedge tool 100 installed in this manner, the door is unable to close due to the presence of the door wedge tool 100 in the hinge 200 within the space between the frame leaf 202 and the door leaf 204, such that the leaves 202, 204 cannot become adjacent to each other. As the door swings to close, the secondary wedging surface 108 comes into contact with either of the leaves 202, 204, thus keeping the door open at approximately a 45 degree angle with the door wedge tool 100 jammed between the door and the frame. The anti-slip element 116 improves the frictional force generated by the door wedge tool 100 against the door and the door frame thus reducing the risk that the door wedge tool 100 will be dislodged. Keeping the door open specifically at a 45 degree angle can be advantageous if it is necessary to maintain ready access to something located behind the door, such as a breaker panel. The secondary wedging surface 108, which can be created by cutting off one of the otherwise three points of a triangular wedge is important to facilitate better seating inside the door hinge area.

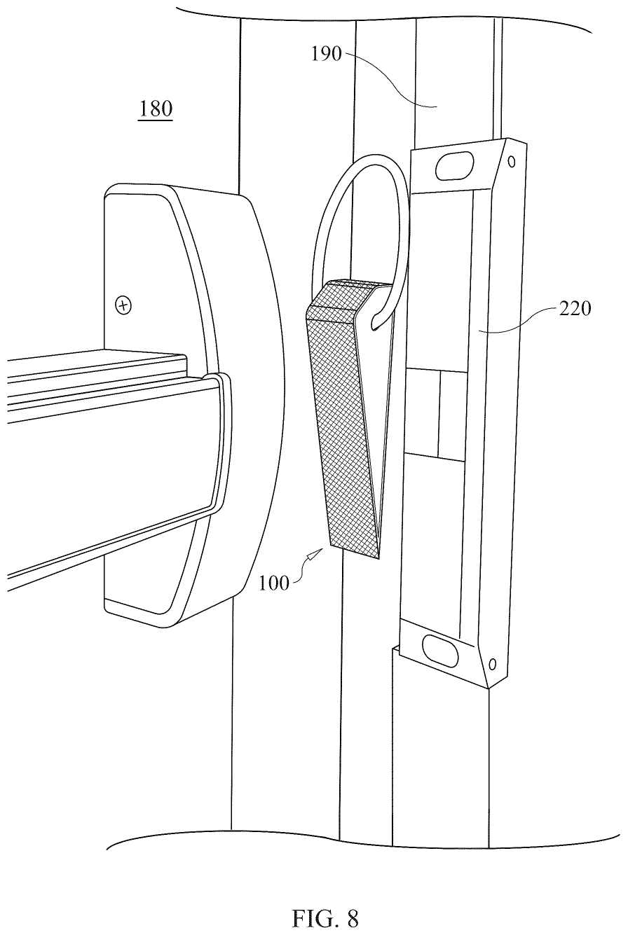

As shown in FIG. 8, the door wedge tool 100 can also be placed on a striker plate 260 or other door latch mechanism to prevent a door from fully closing and locking. The door wedge tool 100 can be placed such that the magnet 118 is attracted to the striker plate 260. With the door wedge tool 100 installed in this manner, the door is unable to fully close because the door wedge tool 100 prevents the door from swinging completely into the door frame to close. The same result can be achieved by placing the door wedge tool 100 directly on the frame in case the frame is made of magnetic metal. Blocking the door from fully closing may be desired to prevent the locking mechanism of the door from engaging, which may unintentionally block access through the door if the locking mechanism can only be opened from one side of the door or the locking mechanism is otherwise inoperable. Preventing the door from locking closed may also be beneficial by avoiding the need for operating the locking mechanism, thus allowing faster passage through the doorway.

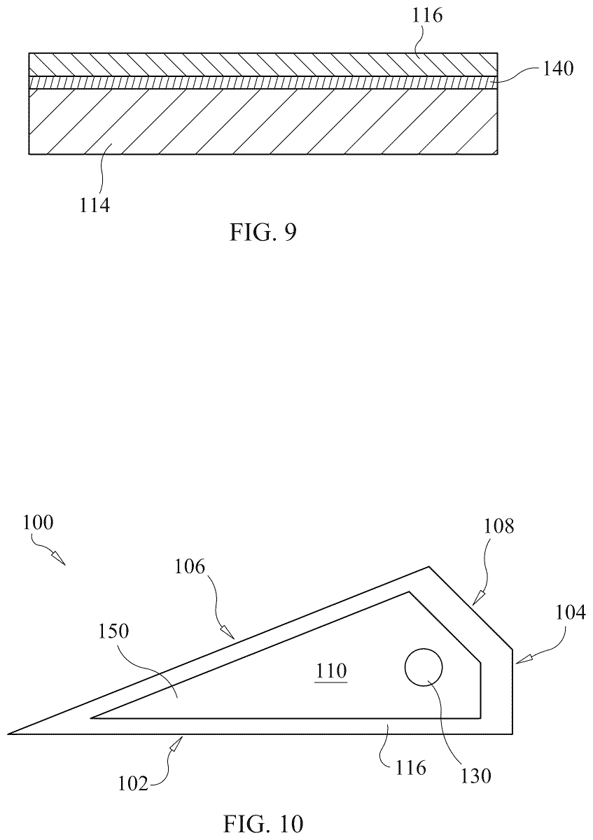

In some embodiments, a phosphorescent layer 140 is adhered to the body 114 to improve the overall visibility of the door wedge tool 100 in low light conditions, allowing users of the device to locate it quickly during an emergency. The phosphorescent layer 140 can be applied to any of the surfaces 102, 104, 106, 108, 110, 112. Referring to FIG. 9, which shows a partial cross-sectional view of the door wedge tool 100, the phosphorescent layer 140 can be applied to the body 114 beneath the anti-slip element 116, with the anti-slip element 116 being adhered to the phosphorescent layer 120. In this embodiment, the anti-slip element 116 is transparent or translucent to light emitted by the phosphorescent layer 140. The phosphorescent layer 140 can be provided in different colors, which can be useful for color-coding. Color-coding can be used to mark and indicate different situations related to the wedged door or the room behind the door. The phosphorescent layer 140 can also include printed indicia on its surface, thus providing further options for marking a wedged door. In some embodiments, the anti-slip element 116 can be phosphorescent.

In some embodiments, the lateral surfaces 110, 112 can include a reflective element 150. The reflective element 150 can be adhered to the body 114. For example, FIG. 10 shows edges of the lateral surface 110 including the anti-slip coating 116 and the remaining center area of the lateral surface 110 including the reflective coating 150. The reflective coating improves overall visibility of the wedge 100, especially at a long range when illuminated by a flashlight or other light source, allowing users of the device to locate it quickly during an emergency. The reflective coating can be provided in different colors, which may be useful for color-coding which may be used to mark and indicate different situations related to the wedged door or the room behind the door.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A door wedge tool comprising:
a base surface;
an end surface defining a first angle with the base surface and extending from a first end of the base surface;
a primary wedging surface defining a second angle with the base surface and extending from a second end of the base surface; and
a magnet recessed through the base surface.

2. The door wedge of claim 1 wherein the second angle is less than 45 degrees.

3. The door wedge tool of claim 1, further comprising:
a secondary wedging surface connecting the end surface and the primary wedging surface, the secondary wedging surface being non-parallel with the primary wedging surface and the end surface.

4. The door wedge tool of claim 3, wherein an angle between the secondary wedging surface and the primary wedging surface is greater than 90 degrees, and an angle between the secondary wedging surface and the end surface is greater than 90 degrees.

5. The door wedge tool of claim 3, wherein the base surface, the end surface, the primary wedging surface, and the secondary wedging surface together complete a fully annular path.

6. The door wedge tool of claim 1, further comprising an anti-slip coating adhered to one or more of the base surface, the primary wedging surface, and the end surface.

7. The door wedge tool of claim 1, further comprising a phosphorescent layer adhered to one or more of the base surface, the primary wedging surface, and the end surface.

8. The door wedge tool of claim 1, further comprising:
a first lateral surface connecting the base surface, the end surface, and the primary wedging surface; and
a second lateral surface connecting the base surface, the end surface, and the primary wedging surface.

9. The door wedge tool of claim 8, further comprising a reflective coating adhered to one or both of the first lateral surface and the second lateral surface.

10. The door wedge tool of claim 8, further comprising a hole through the first lateral side and the second lateral side.

11. The door wedge tool of claim 1, wherein the magnet is closer to the end surface than the primary wedging surface.

12. The door wedge tool of claim 1, further comprising a center of gravity, the magnet being located along the base surface offset from the center of gravity approximately perpendicular with respect to the base surface.

13. A door wedge tool comprising:
a base surface;
an end surface defining a first angle with the base surface and extending from a first end of the base surface;
a primary wedging surface defining a second angle with the base surface and extending from a second end of the base surface, the second angle being less than 45 degrees; and
a secondary wedging surface connecting the end surface and the primary wedging surface, the secondary wedging surface being non-parallel with the primary wedging surface and the end surface.

14. The door wedge tool of claim 13, further comprising:
a third angle between the secondary wedging surface and the primary wedging surface, the third angle being greater than 90 degrees; and
a fourth angle between the secondary wedging surface and the end surface, the fourth angle being greater than 90 degrees.

15. The door wedge tool of claim 13, wherein the base surface, the end surface, the primary wedging surface, and the secondary wedging surface together complete a fully annular path.

16. The door wedge tool of claim 13, further comprising an anti-slip coating adhered to one or more of the base surface, the primary wedging surface, and the end surface.

17. The door wedge tool of claim 13, further comprising a phosphorescent layer adhered to one or more of the base surface, the primary wedging surface, and the end surface.

18. The door wedge tool of claim 13, further comprising:
a first lateral surface connecting the base surface, the end surface, and the primary wedging surface; and
a second lateral surface connecting the base surface, the end surface, and the primary wedging surface.

19. The door wedge tool of claim 18, further comprising a reflective coating adhered to one or both of the first lateral surface and the second lateral surface.

20. The door wedge of claim 18, further comprising a hole through the first lateral side and the second lateral side.

21. The door wedge tool of claim 13, further comprising a magnet recessed through the base surface.

22. The door wedge tool of claim 13, wherein the first angle is approximately 90 degrees and a third angle between the end surface and the secondary wedging surface is approximately 135 degrees.

23. The door wedge tool of claim 22, wherein the second angle ranges between 15-30 degrees and a fourth angle between the secondary wedging surface and the primary wedging surface is between 105-120 degrees.
